(19) United States
(12) Patent Application Publication
(10) Pub. No.: US 2024/0327947 A1
(43) Pub. Date: Oct. 3, 2024

(54) MINERAL PROCESSING METHOD

(71) Applicants: KYUSHU UNIVERSITY, NATIONAL UNIVERSITY CORPORATION, Fukuoka-shi (JP); SUMITOMO METAL MINING CO., LTD., Tokyo (JP)

(72) Inventors: Tsuyoshi HIRAJIMA, Tokyo (JP); Hajime MIKI, Fukuoka-shi (JP); Gde Pandhe Wisnu SUYANTARA, Fukuoka-shi (JP); Keiko SASAKI, Fukuoka-shi (JP); Yoshiyuki TANAKA, Niihama-shi (JP); Eri TAKIDA, Niihama-shi (JP)

(73) Assignees: KYUSHU UNIVERSITY, NATIONAL UNIVERSITY CORPORATION, Fukuoka-shi (JP); SUMITOMO METAL MINING CO., LTD., Tokyo (JP)

(21) Appl. No.: 18/739,039

(22) Filed: Jun. 10, 2024

Related U.S. Application Data
(63) Continuation of application No. PCT/JP2022/044657, filed on Dec. 5, 2022.

(30) Foreign Application Priority Data
Dec. 17, 2021 (JP) 2021-204786

(51) Int. Cl. C22B 1/11; C22B 15/00

(52) U.S. Cl. CPC C22B 1/11; C22B 15/0008; C22B 15/0089

(57) ABSTRACT

Provided is a mineral processing method that allows obtaining a concentrate having a low arsenic grade from a raw material having a high arsenic grade. The mineral processing method includes: a repulping step of adding water to a raw material containing a non-arsenic-containing sulfide mineral as a sulfide mineral not containing arsenic and an arsenic-containing sulfide mineral as a copper sulfide mineral containing arsenic to obtain a mineral slurry; a pH adjusting step of adjusting a pH of a liquid phase of the mineral slurry to 10 or more; a conditioning step of adding an oxidant and xanthate alkali metal salt to the mineral slurry; and a flotation step of performing flotation using the mineral slurry to separate the raw material into a floating ore having a grade of the non-arsenic-containing sulfide mineral higher than a grade of the non-arsenic-containing sulfide mineral of the raw material and a precipitating ore having a grade of the arsenic-containing sulfide mineral higher than a grade of the arsenic-containing sulfide mineral of the raw material. The raw material contains the arsenic by 4.4 to 5.8 pts. wt. per 100 pts. wt. of copper.

### TECHNICAL FIELD

The present invention relates to a mineral processing method. More specifically, the present invention relates to the mineral processing method for obtaining a concentrate having a low arsenic grade from a raw material having a high arsenic grade.

### BACKGROUND ART

In a field of copper smelting, various methods for recovering copper from raw materials containing copper such as copper ores and copper concentrates have been proposed. For example, the following processing is performed to recover copper from the copper ores.

### (1) Mineral Processing Step

In the mineral processing step, after grinding copper ores mined from a mine, water is added to form a slurry, and then flotation is performed. The flotation is performed by adding a flotation agent composed of a collector, a depressant, a frothing agent, and the like to the slurry, blowing air into the slurry to cause copper minerals to float and gangue to precipitate for separation. Thus, a copper concentrate with a copper grade of approximately 30% can be obtained.

### (2) Pyrometallurgical Smelting Step

In the pyrometallurgical smelting step, the copper concentrate obtained in the mineral processing step melts by using a furnace such as a flash furnace, undergoes a converter and a refining furnace, and is refined up to crude copper with the copper grade of about 99%. The crude copper is cast into anodes used in an electrolysis step of the next step. Here, arsenic contained in the copper concentrate is distributed to slug, dust, and crude copper.

### (3) Electrolysis Step

In the electrolysis step, the anodes are inserted into an electrolytic cell filled with a sulfuric acidic solution (electrolyte) and electric current is passed between the anodes and cathodes, thus performing an electrolytic refining. By the electrolytic refining, copper of the anodes is dissolved and is deposited on the cathodes as electrolytic copper with a purity of 99.99%.

An anode slime generated by the electrolytic refining contains noble metal, arsenic, and the like eluded from the anodes. The anode slime is processed in a noble metal recovering step to recover the noble metal. A residue discharged in the noble metal recovering step contains arsenic.

In the slug discharged in the pyrometallurgical smelting step, the arsenic is fixed in a stable form. The slug is granulated with water and used for, for example, a filler. On the other hand, the dust discharged in the pyrometallurgical smelting step and the arsenic contained in the residue discharged in the noble metal recovering step are in an unstable form. Since discharging the dust and the residue as is to the outside of the system is unpreferable, they are repeatedly charged to the furnace. Thus, the most arsenic contained in the copper concentrate is finally distributed to the slug and fixed in the stable form.

Nowadays, circumstances of raw materials are changing. Copper mines producing copper ores having low arsenic grades are in the way of depletion, and the arsenic grades of the obtained copper ores increase every year. In association with this, the arsenic grade of the copper concentrate is gradually increasing. Therefore, even when a throughput of copper concentrates is the same as before, the throughput of the arsenic increases, and there may be a case where processing of fixing arsenic to slugs cannot catch up. Therefore, obtaining copper concentrates having low arsenic grades from copper ores having high arsenic grades is required.

Patent Document 1 discloses that flotation using a chelating agent as a depressant separates arsenic mineral from a substance containing copper having a high arsenic grade to obtain a copper concentrate having a low arsenic grade. Patent Document 2 discloses that xanthate alkali metal salt is added to a mineral slurry, flotation is performed, a non-arsenic-containing sulfide mineral is recovered as a precipitating ore, and an arsenic-containing sulfide mineral is recovered as a floating ore.

### CITATION LIST

### Patent Literature

Patent Document 1: JP-A-2011-156521
Patent Document 2: JP-A-2020-104095

### SUMMARY OF INVENTION

### Technical Problem

The present invention is in consideration of the circumstances, and an object of the present invention is to provide a mineral processing method that allows obtaining a concentrate having a low arsenic grade from a raw material having a high arsenic grade.

### Solution to Problem

A mineral processing method according to a first aspect includes: a repulping step of adding water to a raw material containing a non-arsenic-containing sulfide mineral as a sulfide mineral not containing arsenic and an arsenic-containing sulfide mineral as a copper sulfide mineral containing arsenic to obtain a mineral slurry; a pH adjusting step of adjusting a pH of a liquid phase of the mineral slurry to 10 or more; a conditioning step of adding an oxidant and xanthate alkali metal salt to the mineral slurry; and a flotation step of performing flotation using the mineral slurry to separate the raw material into a floating ore having a grade of the non-arsenic-containing sulfide mineral higher than a grade of the non-arsenic-containing sulfide mineral of the raw material and a precipitating ore having a grade of the arsenic-containing sulfide mineral higher than a grade of the arsenic-containing sulfide mineral of the raw material. The raw material contains the arsenic by 4.4 to 5.8 pts. wt. per 100 pts. wt. of copper.

In a mineral processing method according to a second aspect, which is in the first aspect, the oxidant is hydrogen peroxide.

In a mineral processing method according to a third aspect, which is in the first or second aspect, the xanthate alkali metal salt is amylxanthic acid potassium.

A mineral processing method according to a fourth aspect, which is in any of the first to third aspects, includes a pretreatment step of washing the raw material with water and/or performing ore polishing on the raw material.

### Advantageous Effects of Invention

The present invention allows obtaining a concentrate having a low arsenic grade by removing the arsenic-containing sulfide mineral from the raw material having the high arsenic grade.

### BRIEF DESCRIPTION OF DRAWINGS

FIG. 1 is a graph showing a relationship between a pH and Newton efficiency.

### DESCRIPTION OF EMBODIMENTS

Next, embodiments of the present invention will be described based on the drawings.

A mineral processing method according to an embodiment of the present invention is a method for removing arsenic from a raw material by flotation using the raw material containing arsenic to obtain a concentrate having a low arsenic grade.

In addition to ores mined from a mine, as the raw material, concentrates obtained by removing gangues from ores by another mineral processing method or the like are used. The raw material contains a plurality of kinds of minerals. The minerals contained in the raw material include, for example, chalcopyrite (CuFeS₂), bornite (CusFeS₄), chalcocite (Cu₂S), pyrite (FeS₂), enargite (Cu₃AsS₄), and tennantite (Cu,Fe,Zn)₁₂(Sb,As)₄S₁₃).

In this Description, a sulfide mineral not containing arsenic is referred to as a “non-arsenic-containing sulfide mineral.” Additionally, a copper sulfide mineral containing arsenic is referred to as an “arsenic-containing sulfide mineral.” The raw material at least contains a non-arsenic-containing sulfide mineral and an arsenic-containing sulfide mineral.

The non-arsenic-containing sulfide mineral includes a copper sulfide mineral not containing arsenic and an iron sulfide mineral not containing arsenic. The raw material may contain one of the copper sulfide mineral not containing arsenic and the iron sulfide mineral not containing arsenic, or may contain both of them.

Examples of the copper sulfide mineral not containing arsenic include chalcopyrite, bornite, and chalcocite. Examples of the iron sulfide mineral not containing arsenic include chalcopyrite, bornite, and pyrite. Note that chalcopyrite and bornite are copper sulfide minerals and also iron sulfide minerals. The raw material may contain any one kind of chalcopyrite, bornite, chalcocite, and pyrite, or may contain two or more kinds of them.

Examples of the arsenic-containing sulfide mineral include enargite and tennantite. The raw material may contain one of enargite and tennantite, or may contain both of them.

The raw material contains the arsenic by 4.4 to 5.8 pts. wt. per 100 pts. wt. of the copper. Note that this Description represents the weight rate of the arsenic to the copper contained in the raw material as As/Cu. Accordingly, As/Cu of the raw material is from 4.4 to 5.8%. The grade of the raw material is, for example, 28.0 to 30.2 weight % of the copper and 1.3 to 1.7 weight % of the arsenic.

### (1) Pretreatment Step

The raw material is preliminarily ground, and isolated mineral particles are mixed. The granularity of the mineral particles is adjusted such that a single mineral can be obtained according to the size of the mineral contained in the ore. For example, the granularity is generally adjusted to around 100 μm under a sieve in the case of chalcopyrite. In a real operation using an ore containing various kinds of minerals as the raw material, after grinding around 100 μm under a sieve, considering flotation results or the like, the granularity of the ore is generally adjusted to be an optimal condition.

After grinding, there may be a case where storage of the mineral particles for a long time changes the surface state of the mineral. For example, oxide, a sulfuric acid compound, hydroxide, and sulfur are generated on the surfaces of the mineral particles, and they may cover the surfaces of the mineral particles. In this case, before the mineral particles are charged to the next step, adhered substances on the surface of the mineral are preferably removed. The method for removing the adhered substance includes water washing, ore polishing, and the like.

The water washing is performed by repeating the operation of adding water to the raw material, stirring the product, and performing solid-liquid separation. A pH can be an index for the degree of water washing. For example, assume that a pH of a liquid phase of a mineral slurry at the beginning of water washing is around 3. In this case, it is only necessary to repeat the water washing operation until the pH of the liquid phase of the mineral slurry increases up to around 4 to 4.5. After the water washing, dehydration is preferably performed to remove the water attached to the mineral particles.

Examples of the method for ore polishing include shear agitation, frictional pulverization (attrition), ball mill grinding, and rod mill grinding. Among them, frictional pulverization (attrition) is preferred. The frictional pulverization means an operation that polishes up surfaces of mineral particles at a strength to the extent of not breaking the mineral particles. An example of a specific method for the frictional pulverization for mineral particles adjusted to around 100 μm under a sieve includes a method for performing rod mill grinding in a short time around 10 minutes.

One of the water washing and the ore polishing may be performed, or both of them may be performed. When both of the water washing and the ore polishing are performed, the order is not specifically limited. When, for example, an adhered substance is absent on the surfaces of the mineral particles, the water washing or the ore polishing need not be performed.

### (2) Repulping Step

Water is added to the raw material formed of the mineral particles to obtain a mineral slurry. It is known that containing calcium ions or magnesium ions in the liquid phase of the mineral slurry adversely affects flotation. Therefore, the water added to the mineral particles are preferably pure water not containing impurity ions. Industrially, ion exchanged water or industrial water may be used.

### (3) pH Adjusting Step

Next, the pH of the liquid phase of the mineral slurry is adjusted to be 10 or more. The pH is adjusted by adding a pH adjuster to the mineral slurry. Although the pH adjuster is not specifically limited, as alkali, sodium hydroxide (NaOH), potassium hydroxide (KOH), calcium hydroxide (Ca(OH)₂), calcium carbonate (CaCO₃), and the like can be used. As the acid, sulfuric acid (H₂SO₄), hydrochloric acid (HCl), and the like can be used. To use the pH adjuster in the form of an aqueous solution, the concentration is not specifically limited, and it is only necessary that the concentration does not make it difficult to adjust the mineral slurry to the objective pH.

### (4) Conditioning Step

Next, an oxidant is added to the mineral slurry, and the mineral slurry is stirred for a predetermined time. The addition of the oxidant oxidizes the surfaces of the mineral particles. As the oxidant, for example, hydrogen peroxide (H₂O₂) and sodium hypochlorite (NaClO) can be used. To use hydrogen peroxide as the oxidant, the additive amount of the hydrogen peroxide is preferably 34.5 to 52.3 kg/t based on the weight of the raw material contained in the mineral slurry.

Additionally, xanthate alkali metal salt is added to the mineral slurry, and the mineral slurry is stirred for a predetermined time. The carbon number of the alkyl group of the xanthate alkali metal salt is not specifically limited. The alkali metal may be sodium or potassium. An example of the xanthate alkali metal salt includes amylxanthic acid potassium. The amylxanthic acid potassium is also referred to as potassium amyl xanthate (PAX), and the chemical formula is C₆H₁₁KOS₂. The amylxanthic acid potassium will be hereinafter represented as “PAX.” PAX is known as a flotation reagent, and it is known that PAX does not have unintended adverse effects.

The xanthate alkali metal salt is expressed by the chemical formula R·O·CS·SM. Here, R indicates an alkyl group, and M indicates alkali metal. The alkyl group R in the formula has hydrophobicity. When CS·SM in the formula discharges the alkali metal M in the liquid, it becomes CS·S⁻ and shows hydrophilicity. When Cu in the mineral discharges electrons during flotation, it binds to CS·S⁻. Accordingly, the alkyl group R appears on the surface of the mineral particle. Therefore, the mineral particles exhibit hydrophobicity.

The additive amount of the PAX is preferably 19.5 to 61.9 g/t based on the weight of the raw material contained in the mineral slurry.

Note that a flotation reagent formed of, for example, a collector, a depressant, and a frothing agent may be further added to the mineral slurry. When the addition of the oxidant and the xanthate alkali metal salt changes the pH of the liquid phase of the mineral slurry, a pH adjuster is added again to adjust the pH of the liquid phase of the mineral slurry to 10 or more.

### (5) Floatation Step

Next, flotation is performed using the mineral slurry. The device or the method used for the flotation is not specifically limited, and a general multi-stage flotation device may be used.

By the flotation, the non-arsenic-containing sulfide mineral can be separated as a floating ore, and the arsenic-containing sulfide mineral can be separated as a precipitating ore. To be more precise, the raw material can be separated into the floating ore having the grade of the non-arsenic-containing sulfide mineral higher than the grade of the non-arsenic-containing sulfide mineral of the raw material and the precipitating ore having the grade of the arsenic-containing sulfide mineral higher than the grade of the arsenic-containing sulfide mineral of the raw material.

Note that repeating the above-described flotation allows further reduction in the arsenic grade of the floating ore. Therefore, even when the raw material has the high arsenic grade, a concentrate having a sufficiently low arsenic grade can be obtained.

Removing the arsenic-containing sulfide mineral from the raw material having the high arsenic grade allows obtaining the concentrate having the low arsenic grade. For example, in copper smelting, even when a copper ore having a high arsenic grade is used, the arsenic grade of the copper concentrate can be preliminarily reduced. Therefore, a process of fixing the arsenic to a slug can be unproblematically performed.

As described above, in the flotation using the raw material containing the non-arsenic-containing sulfide mineral and the arsenic-containing sulfide mineral, when the oxidant and the xanthate alkali metal salt are added to the mineral slurry, the non-arsenic-containing sulfide mineral can be separated as the floating ore, and the arsenic-containing sulfide mineral can be separated as a precipitate.

Generally, the PAX functions as a collector to recover sulfide as a floating ore. Accordingly, it is expected that addition of the PAX to the mineral slurry recovers both of the non-arsenic-containing sulfide mineral and the arsenic-containing sulfide mineral as floating ores. Actually, it has been confirmed that, in flotation using each of chalcopyrite as a non-arsenic-containing sulfide mineral and enargite and tennantite as arsenic-containing sulfide minerals alone, when PAX is added to the mineral slurry, the most parts of all of the minerals are recovered as floating ores.

However, under the conditions of this embodiment, while the addition of the PAX to the mineral slurry recovers the most part of the arsenic-containing sulfide mineral as the precipitating ore, the most part of the non-arsenic-containing sulfide mineral is recovered as the floating ore. Accordingly, it is considered that while the function of the PAX as the collector for the arsenic-containing sulfide mineral is suppressed, the PAX maintains the function as the collector for the non-arsenic-containing sulfide mineral.

Patent Document 2 discloses that the oxidant and the PAX are added to the mineral slurry, the flotation is performed, the non-arsenic-containing sulfide mineral is recovered as the precipitating ore, and the arsenic-containing sulfide mineral is recovered as the floating ore. While the arsenic is condensed to the precipitating ore under the conditions of this embodiment, the arsenic is condensed to the floating ore under the conditions of Patent Document 2. It is considered that this different is mainly caused by the difference in the weight rate of the arsenic to the copper (As/Cu) contained in the raw material.

That is, As/Cu is equal to 4.4 to 5.8% in this embodiment. In contrast to this, As/Cu is equal to 6.1 to 35.6% in Patent Document 2 (Examples 1 to 39). The As/Cu is considered to affect the degree of oxidation generated by the electric potential difference between the non-arsenic-containing sulfide mineral and the arsenic-containing sulfide mineral (the difference in galvanic electric potential). In this embodiment, it is inferred that the difference from Patent Document 2 in As/Cu increases the hydrophilicity of the arsenic-containing sulfide mineral or increases the hydrophobicity of the non-arsenic-containing sulfide mineral. Therefore, the arsenic-containing sulfide mineral is recovered as the floating ore.

### EXAMPLES

Next, the examples will be described.

A test that separated non-arsenic-containing copper sulfide mineral and arsenic-containing copper sulfide mineral contained in a copper concentrate by flotation was conducted.

The copper concentrate is particulate and has a grain diameter of 100 μm under a sieve. The analysis of the composition of the copper concentrate using an X-ray fluorescence spectrometer (XRF, Rigaku, ZSX Primus II, the same applies hereinafter) turned out that the copper was 28.0 to 30.2 weight %, the arsenic was 1.3 to 1.7 weight %, and the weight rate of the arsenic to the copper (As/Cu) was 4.4 to 5.8%.

An operation of adding water to the copper concentrate, stirring the product for 10 minutes at 1,150 rpm, and after that performing a solid-liquid separation was repeated three times for water washing of the copper concentrate. Afterwards, 875 g of the copper concentrate and 875 mL of the water were charged in a rod mill, the rod mill was operated for 10 minutes, and ore polishing was performed.

Water was added to the mineral slurry to adjust the solid content concentration to 33 weight %. Calcium hydroxide was added to the mineral slurry to adjust the pH. Next, hydrogen peroxide was added to the mineral slurry, and the mineral slurry was stirred for 30 minutes. Next, the PAX was added, and the mineral slurry was stirred for three minutes. Next, MIBC was added, and the mineral slurry was stirred for one minute.

Using a Denver flotation machine having a capacity of 5 L, a rotation speed of a bubble supply type stirring blade was set to 1,150 rpm, and flotation was performed for 30 minutes to obtain a floating ore and a precipitating ore.

The weight of each of the obtained floating ore and precipitating ore was measured, and the element composition and the mineral composition of each of the obtained floating ore and precipitating ore were analyzed. The XRF was used for analysis of the element composition. An MLA analysis method was used for analysis of the mineral composition. Additionally, Newton efficiency indicative of separation efficiency between the non-arsenic-containing copper sulfide mineral and the arsenic-containing copper sulfide mineral by flotation was obtained from the analysis results. The Newton efficiency is obtained in the following procedure.

First, a floating ore rate R and a precipitating ore rate L are obtained by the formulae (1) and (2).

$$R = Wr / ( Wr + Wl ) \qquad ( 1 )$$

$$L = Wl / ( Wr + Wl ) \qquad ( 2 )$$

Here, Wr indicates the weight of the floating ore, and Wl indicates the weight of the precipitating ore. The floating ore rate R means the weight rate of the floating ore in the mineral recovered as the floating ore and the precipitating ore. The precipitating ore rate L means the weight rate of the precipitating ore in the mineral recovered as the floating ore and the precipitating ore.

A floating ore rate R_{N-As} of the non-arsenic-containing copper sulfide mineral is obtained by the formula (3).

$${R}_{N - As} = R \times Gr ( {Cu}_{N - As} ) / ( R \times Gr ( {Cu}_{N - As} ) + L \times Gl ( {Cu}_{N - As} ) \qquad ( 3 )$$

Here, Gr (Cu_{N-As}) is the grade of the copper contained in the non-arsenic-containing copper sulfide mineral of the floating ore, and Gl(Cu_{N-As}) is the grade of the copper contained in the non-arsenic-containing copper sulfide mineral of the precipitating ore. Gr(Cu_{N-As}) and Gl(Cu_{N-As}) are obtained from the copper grades and the mineral compositions of the floating ore and the precipitating ore. The floating ore rate R_{N-As} of the non-arsenic-containing copper sulfide mineral means the weight rate of the floating ore in the arsenic-containing copper sulfide mineral recovered as the floating ore and the precipitating ore.

The floating ore rate R_{As} of the arsenic-containing copper sulfide mineral is obtained by the formula (4).

$${R}_{As} = R \times Gr ( {Cu}_{As} ) / ( R \times Gr ( {Cu}_{As} ) + L \times Gl ( {Cu}_{As} ) ) \qquad ( 4 )$$

Here, Gr(Cu_{As}) is the grade of the copper contained in the arsenic-containing copper sulfide mineral of the floating ore, and Gl(Cu_{As}) is the grade of the copper contained in the arsenic-containing copper sulfide mineral of the precipitating ore. Gr(Cu_{As}) and Gl(Cu_{As}) are obtained from the copper grades and the mineral compositions of the floating ore and the precipitating ore. The floating ore rate R_{As} of the arsenic-containing copper sulfide mineral means the weight rate of the floating ore in the arsenic-containing copper sulfide mineral recovered as the floating ore and the precipitating ore.

Newton efficiency ηN is obtained by the formula (5) using the floating ore rate R_{N-As} of the non-arsenic-containing copper sulfide mineral and the floating ore rate R_{As} of the arsenic-containing copper sulfide mineral. The Newton efficiency ηN having a positive value means that the arsenic-containing copper sulfide mineral is condensed to the precipitating ore.

$$η N = {R}_{N - As} - {R}_{As} \qquad ( 5 )$$

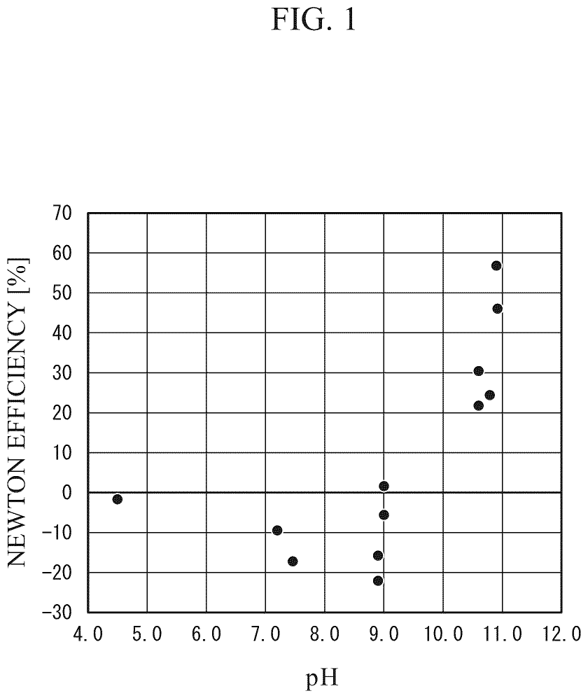

The test in the above-described procedure was conducted 12 times. Table 1 shows the grade of the copper concentrate used in each of the tests, the amount of additive, the pH, and the Newton efficiency. FIG. 1 illustrates the relationship between the pH and the Newton efficiency. Note that pH indicates the value after addition of the additive.

TABLE 1

| | Copper concentrate grade | | | Additive | | | | Newton |
|---|---|---|---|---|---|---|---|---|
| | Cu | As | As/Cu | H₂O₂ | PAX | MIBC | | efficiency |
| | [weight %] | [weight %] | [%] | [kg/t] | [g/t] | [g/t] | pH | [%] |
| Test 1 | 29.3 | 1.5 | 5.1 | 36.57 | 61.77 | 19.01 | 4.5 | −1.75 |
| Test 2 | 29.4 | 1.7 | 5.8 | 36.43 | 61.46 | 18.94 | 7.2 | −9.52 |
| Test 3 | 29.3 | 1.4 | 4.8 | 36.48 | 61.62 | 18.97 | 7.5 | −17.28 |
| Test 4 | 29.2 | 1.5 | 5.1 | 36.62 | 61.85 | 51.98 | 8.9 | −15.84 |
| Test 5 | 28.3 | 1.5 | 5.3 | 36.49 | 61.63 | 9.49 | 8.9 | −22.16 |
| Test 6 | 28.9 | 1.6 | 5.5 | 36.43 | 61.53 | 18.94 | 9.0 | 1.55 |
| Test 7 | 28.2 | 1.5 | 5.3 | 52.29 | 58.81 | 18.12 | 9.0 | −5.67 |
| Test 8 | 29.3 | 1.5 | 5.1 | 35.54 | 20.01 | 9.24 | 10.6 | 30.38 |
| Test 9 | 30.2 | 1.4 | 4.6 | 36.26 | 20.41 | 18.85 | 10.6 | 21.7 |
| Test 10 | 29.7 | 1.3 | 4.4 | 34.54 | 19.45 | 17.96 | 10.8 | 24.34 |
| Test 11 | 28.5 | 1.4 | 4.9 | 36.22 | 61.17 | 9.42 | 10.9 | 56.77 |
| Test 12 | 28.0 | 1.4 | 5.0 | 36.46 | 61.59 | 9.48 | 10.9 | 46.01 |

As seen from FIG. 1, the Newton efficiency becomes negative values in a region where the pH is low (9 or less). This means that the arsenic-containing copper sulfide mineral is condensed to the floating ore. On the other hand, the Newton efficiency becomes positive values in a region where the pH is 10 or more. This means that the arsenic-containing copper sulfide mineral is condensed to the precipitating ore. Moreover, the absolute values of Newton efficiency are large in a region where the pH is 10 or more. This means that the arsenic-containing copper sulfide mineral and the non-arsenic-containing copper sulfide mineral can be efficiently separated. Accordingly, it has been confirmed that 10 or more of the pH allows efficiently removing the arsenic-containing copper sulfide mineral. Although the upper limit of pH is unknown, it can be said that the similar trend is observed at the pH 12 or less or at least the pH 11 or less.

1. A mineral processing method comprising:
a repulping step of adding water to a raw material containing a non-arsenic-containing sulfide mineral as a sulfide mineral not containing arsenic and an arsenic-containing sulfide mineral as a copper sulfide mineral containing arsenic to obtain a mineral slurry;
a pH adjusting step of adjusting a pH of a liquid phase of the mineral slurry to 10 or more;
a conditioning step of adding an oxidant and xanthate alkali metal salt to the mineral slurry; and
a flotation step of performing flotation using the mineral slurry to separate the raw material into a floating ore having a grade of the non-arsenic-containing sulfide mineral higher than a grade of the non-arsenic-containing sulfide mineral of the raw material and a precipitating ore having a grade of the arsenic-containing sulfide mineral higher than a grade of the arsenic-containing sulfide mineral of the raw material, wherein
the raw material contains the arsenic by 4.4 to 5.8 pts. wt. per 100 pts. wt. of copper.

2. The mineral processing method according to claim 1, wherein
the oxidant is hydrogen peroxide.

3. The mineral processing method according to claim 1, wherein
the xanthate alkali metal salt is amylxanthic acid potassium.

4. The mineral processing method according to claim 1, comprising
a pretreatment step of washing the raw material with water and/or performing ore polishing on the raw material.
